(19) United States
(12) Patent Application Publication
(10) Pub. No.: US 2017/0010197 A1
(43) Pub. Date: Jan. 12, 2017

(54) METHOD AND DEVICE FOR DETERMINING CHARACTERISTIC PROPERTIES OF A TRANSPARENT PARTICLE

(71) Applicant: TECHNISCHE UNIVERSITAET DARMSTADT, Darmstadt (DE)

(72) Inventors: Cameron TROPEA, Gross-Umstadt (DE); Walter SCHAEFER, Aschaffenburg (DE)

(21) Appl. No.: 15/212,314

(22) Filed: Jul. 18, 2016

Related U.S. Application Data
(63) Continuation of application No. 14/239,164, filed on Jun. 2, 2014, now abandoned.

(30) Foreign Application Priority Data
Aug. 17, 2011 (DE) 10 2011 052 783.4
Mar. 20, 2012 (DE) 10 2012 102 361.1

(51) Int. Cl. G01N 15/02; G01N 15/14; G01N 21/41

(52) U.S. Cl. CPC G01N 15/0211; G01N 21/4133; G01N 15/1434; G01N 2015/0222; G01N 2015/0238; G01N 2201/0621; G01N 2015/1493

(57) ABSTRACT

The invention relates to a method for determining the size d of a transparent particle, according to which method the particle is illuminated with light from a light source, a radiation detector measures a time-resolved intensity profile of light of the light source scattered by the particle, a reflection peak (10) and a refraction peak are determined in the intensity profile and the size d of the particle is determined based on a time difference between the reflection peak (10) and the refraction peak. The method according to the invention is characterized in that the time-resolved intensity profile is measured at a definable scattering angle θs, a first second-order refraction peak (11) and a second second-order refraction peak (12) having a mode different from that of the first refraction peak (11) being determined, a characteristic variable γ being determined as the ratio of a first time difference Δt₀₁ between the reflection peak (10) and the first refraction peak (11) and of a second time difference Δt₀₂ between the reflection peak (10) and the second refraction peak (11), and the size of only those particles being determined for which the characteristic variable γ corresponds to a definable value.

### CROSS REFERENCE TO RELATED APPLICATIONS

This application is a continuation of US application Ser. No. 14/239,164, filed Jun. 2, 2014, which is a US national stage application of international application PCT/EP2012/066130, filed Aug. 17, 2012 designating the United States, which is incorporated herein by reference in its entirety and which claims priority to German patent applications DE 10 2011 052 783.4, filed Aug. 17, 2011 and DE 10 2012 102 361.1, filed Mar. 20, 2012.

### BACKGROUND OF THE INVENTION

The invention relates to a method for determining characteristic properties of a transparent particle, wherein the particle is illuminated with light from a light source, wherein a time-resolved intensity profile of light from the light source that is scattered at the particle is measured by a radiation detector at a predefinable scattering angle es, wherein characteristic scattered light peaks are determined in the intensity profile, and wherein a size of the particle is determined based on a time difference between two scattered light peaks.

The determination of various characteristic properties of individual particles having a size which lies in the millimeter range and below is of considerable importance both for research and also for the industrial and commercial use of products or methods. The properties of interest in each case are often the size, the shape, the speed and the refractive index of individual particles. The simultaneous determination of both the size and the speed of individual particles are of particular interest since, with this information, it is possible to determine a flow density such as for example a mass flow or a volume flow. In addition, individual particles within a large number of particles can be identified and characterized individually, such as for example individual droplets in an aerosol or spray.

The determination of characteristic properties of individual droplets is required for example in order to optimize processes of injecting a fuel into a combustion chamber or in order to characterize a spray jet of a paint or lacquer during a spraying process. The particles, the properties of which are to be determined, are not only droplets of liquid in a gas, such as air for example, but rather, depending on the application, solid particles, gas bubbles in a liquid or also a droplet emulsion of a first liquid which is distributed in a second liquid.

Various measurement methods are known from practice. In many cases, optical measurement methods are advantageous since these do not or do not markedly influence the individual particles, the properties of which are to be determined.

The optical measurement methods known from practice and from research include for example imaging techniques with a high temporal resolution, intensity measurements, interferometry or the evaluation of reflected and refracted light rays which are scattered by a particle to be measured.

Most of the measurement methods mentioned above require various assumptions about some properties of the particles, depending on the method, or require appropriate preset values in order to be able, in conjunction with the measured values, to determine the desired properties. One condition that is necessary in many cases is the assumption that the individual particles have a spherical shape or surface.

It has been found that usually a considerable complexity in terms of apparatus is required in order to be able to carry out the measurements necessary to determine the characteristic properties. Nonetheless, only a few methods permit a simultaneous determination of the size and speed of individual particles. In many cases, therefore, a plurality of different measurements must be carried out on the same particle in order to be able to determine one or more relevant properties. Here, there is the problem of being able reliably to assign the measurement results of the different measurements to the same particle in each case, in order to enable a further evaluation of the measurement results and a determination of properties of the same particle which are dependent on a plurality of measurement results.

In one method of the type mentioned above, the fact that the light reflected by a particle and the light scattered by birefringence or refracted by said particle at the same angle can be detected in a temporally offset manner is used to determine the size of a particle. The time difference between the two peaks or intensity maxima of the reflected and of the refracted scattered light can, under certain conditions and if the speed of the particle is known, be used to determine the size of the particle. The speed of the particle can be determined via a different measurement method, such as for example with the aid of a laser Doppler system. Such a method is described for example in N. Damaschke, H. Nobach, N. Semidetnov, C. Tropea (2002) Optical Particle Sizing in Backscatter, Applied Optics 41, 5713-5727 or A. Kretschmer, N. Damaschke, N. Semidetnov, C. Tropea (2006) Application of the Time-Shift Technique for Spray Measurement, 13th Int. Symp. on Appl. Laser Techniques to Fluid Mechanics, Lisbon, Portugal, Jun. 26-29, 2006.

While this measurement method delivers good results in theory, the use thereof in practice is often limited. Different intensity maxima may also be produced for example as a result of the fact that two different particles are illuminated one after the other by the light source and scattered light is scattered in the direction of a radiation detector. Particularly in the case of dense accumulations of particles, individual peaks can no longer reliably be assigned to individual particles. In addition, the shape of the measured particles may differ from a spherical shape, so that the geometric assumptions required in order to determine the size are not correct and the determined values may differ considerably from actual size values. In order to be able to check the reliability of the measurement results, a quite considerable complexity in terms of apparatus is required, which in many cases leads to the situation whereby it is not economically viable to use this measurement method.

### SUMMARY OF THE INVENTION

An object of the present invention is therefore considered to be that of configuring a method of the type mentioned above for determining the size of a particle such that a reliable determination of the particle size is possible with the lowest possible design complexity.

This object is achieved according to the invention in that a first time difference is determined between a first pair of scattered light peaks and a second time difference is determined between a second pair of scattered light peaks, in that a characteristic variable is determined as the ratio of the first time difference and the second time difference, and in that a determination of size is carried out only for those particles for which the characteristic variable lies within a predefinable value range.

Here use is made of the fact that, in the scattered light which is scattered or produced by a particle, the temporal spacing of a plurality of scattered light peaks from one another satisfies predefined rules and depends only on a few characteristic properties of the particle in question. If an ideal spherical shape is assumed for the particle, the temporal spacings of the plurality of scattered light peaks from one another depend only on the size and the speed of the particle and on the scattered light angle, wherein the scattered light angle is predefined by the measurement apparatus and is known as a constant in a sufficiently precise manner.

If two time differences between two different pairs of scattered light peaks of the same particle are then compared with one another and a characteristic variable describing this ratio is calculated, the characteristic variable should be consistent for all particles which satisfy the assumptions and have an ideal spherical shape, i.e. a consistent ratio of these time differences should be determined. If the determined characteristic variable differs considerably for a measurement on a particle, either an incorrect measurement has been made or else the assumption of an ideal spherical shape must be wrong.

Deviations from this assumption of an ideal spherical shape of the particle responsible for the measured scattered light are often also caused by the simultaneous crossing of two or more particles through the measurement volume illuminated by the incident light.

With the measurement methods known to date, such superposed scattered light intensities can be ascertained or meaningfully evaluated only if it is ensured, by appropriate preset values, that always just one particle is passing through the measurement volume. As an alternative, the measurement volume could be monitored by additional detectors and the measurement results could be discarded in the event of a plurality of particles passing simultaneously through the measurement volume.

With the method according to the invention, the measurement results themselves can easily be checked and those measured scattered light intensities which do not permit any meaningful evaluation for determining the characteristic particle properties can be identified.

According to one embodiment of the concept of the invention, it is provided that the scattering angle es is greater than 135°. For scattering angles es of less than 135°, refraction maxima of higher order may occur, thereby making it more difficult to evaluate the scattered light intensities. If the light scattered at the particle is measured at a large backscatter angle θₛ and particularly advantageously in a range θₛ>150°, the measurement equipment necessary for carrying out the measurement can be arranged in a space-saving manner on one side of the measurement volume in which the particle to be measured can move. It is not necessary to shine a light through the measurement volume and to arrange individual components of the measuring device on opposite sides of the measurement volume. Moreover, with a measurement at a scattering angle θₛ>135 ° and in particular θₛ>150°, the light yield and thus the signal strength of the refraction peaks is relatively high, so that precise measurement results can be obtained.

It is preferably provided that a first refraction peak and, spaced apart therefrom, a second refraction peak are determined, wherein a characteristic variable y is determined as the ratio of a first time difference between the reflection peak and the first refraction peak and a second time difference between the reflection peak and the second refraction peak, and wherein a determination of size is carried out only for those particles for which the characteristic variable y corresponds to a predefinable value.

According to one embodiment of the concept of the invention, it is provided that the first refraction peak is a second-order refraction peak having a first mode and the second refraction peak is a second-order refraction peak having a second mode. The refraction peaks used to calculate the characteristic variable γ therefore differ in terms of the respective mode. With regard to the respective scattering intensities, advantageously the second-order refraction peaks are used to calculate the characteristic variable γ. It has been found that, with the predefined backscatter (θs>135° and in particular θs>150°), these two second-order refraction peaks as well as the reflection peak have the greatest intensities and the greatest intensity peaks in the scattered light and other scattered light peaks, such as for example higher-order refraction peaks, barely have intensities that are of note or that can be evaluated.

In a known manner, the time difference between the reflection peak and a refraction peak can be used to determine the size of the particle at which the incident light is scattered. Here, use is made of the fact that the time difference between the measurement signals for the reflection peak and for a refraction peak depends on the path length and the spatial distance of the respective differently scattered light rays, which in turn depend in a known manner on the particle size and the speed at which the particle moves through the incident light ray.

If two different time differences, which are assigned to different refraction peaks, are put into ratio with one another, the ratio of the two time differences is no longer dependent on the size of the particle. For the characteristic variable y, which describes the ratio of two time differences between the reflection peak and in each case one associated refraction peak, the formula shown below can be derived:

$$\frac{Δ {t}_{02}}{Δ {t}_{01}} = \frac{\frac{d / 2}{v} ( cos ( \frac{{θ}_{s}}{2} ) + sin ( {θ}_{i}^{p = 2.2} ( {θ}_{s} , m ) ) )}{\frac{d / 2}{v} ( cos ( \frac{{θ}_{s}}{2} ) + sin ( {θ}_{i}^{p = 2.1} ( {θ}_{s} , m ) ) )} = \frac{( cos ( \frac{{θ}_{s}}{2} ) + sin ( {θ}_{i}^{p = 2.2} ( {θ}_{s} , m ) ) )}{( cos ( \frac{{θ}_{s}}{2} ) + sin ( {θ}_{i}^{p = 2.1} ( {θ}_{s} , m ) ) )} := γ ( {θ}_{s} , m )$$

The time differences Δt₀₂ and Δt₀₁ denote the time difference between the reflection peak and the second refraction peak or first refraction peak, respectively. The particle diameter is denoted d and the particle speed is denoted v. The angles of incidence θᵢ^{p=2.2} and θᵢ^{p=2:1} describe the respective angles of incidence of the light of the second-order refraction peak having the second mode or having the first mode, respectively, on the particle. These angles of incidence θᵢ^{p=2.2} and θᵢ^{p=2.1} are for their part geometric variables which, assuming an ideal spherical shape of the particle, depend only on the scattering angle θₛ and the relative refractive index m. The angles of incidence θᵢ^{p=2.2} and θᵢ^{p=21} can be determined beforehand for example using ray tracing programs or suitable simulation programs. The characteristic variable γ therefore depends only on the relative refractive index m of the particle in the surrounding medium and on the scattering angle θₛ as well as on fixedly predefined geometric conditions relating to the scattering angle.

This independence, ascertained by experiments, of the characteristic variable γ from the particle size can be used according to the invention to check whether the measured values of a time-resolved intensity profile that are used to determine the particle size stem from an individual particle and are not for instance the result of a superposition of a plurality of scattering effects at different particles. In addition, the characteristic variable γ can also be used to check that the assumptions used as a basis for a reliable determination of the particle size, such as for example an approximately spherical shape, are satisfied, so that a meaningful determination of size can be carried out.

Measured values for which the characteristic variable γ differs considerably from a predefined value or from a predefined value range are not used to determine the particle size, but rather are discarded. The number of particles for which a determination of the particle size is carried out is reduced due to the discarding of those measurement results for which the characteristic variable y does not satisfy the predefined criterion. For the remaining measured values, however, it is then possible to carry out a much more reliable and thus more precise determination of the particle size.

When using the method according to the invention, it is no longer necessary to check and to validate the significance of individual measurement results through additional and independent measurements. In this way, the complexity in terms of apparatus can be considerably reduced without thereby reducing the precision or significance of the measurement results.

It has been found that a reliable and precise determination of the particle size is aided if the scattering angle θₛ is predefined such that the characteristic variable γ=Δt₀₂/Δt₀₁ is between 1.5 and 2.5, preferably around 2.0. The characteristic variable γ depends, besides the scattering angle θₛ, only on the relative refractive index m, which for a known droplet material in a surrounding and likewise known medium is a known and constant parameter. By suitably predefining the scattering angle θₛ, the value or value range for the characteristic variable γ can be predefined such that the time-resolved intensity profiles measured at this scattering angle θₛ allow the most reliable possible determination of the particle size. It has been found that, with a value of the characteristic variable γ in the region of 2, advantageous conditions exist for reliably separating, identifying and evaluating the individual peaks in the time-resolved intensity profile.

Furthermore, it is also possible in principle to assign one of several known refractive indices to the particle based on the characteristic variable γ. If, for example, a measurement apparatus is simultaneously fed particles of two different materials which differ considerably from one another in terms of their respective refractive index, then a first characteristic variable γ₁ should be determined for all particles of a first material and a second characteristic variable γ₂, which differs considerably from the first characteristic variable γ₁, should be determined for all particles of a second material. All the particles for which the characteristic variable γ₁ is determined can be assigned to the first material. All particles for which the characteristic variable γ₂ is determined can be assigned to the second material. All marginal intensity distributions for which a characteristic variable γ₃ is determined, which differs considerably from the two characteristic variables γ₁ and γ₂, are discarded since they do not allow a reliable evaluation and result from an evaluation of intensity maxima which cannot be assigned to individual particles or to a particle suitable for an evaluation.

It is likewise possible to measure two different time-resolved intensity profiles of the scattered light from a single particle and to use these for the evaluation. The two intensity profiles may either be measured with the aid of two different radiation detectors or may be produced by two light sources which illuminate from different directions the particle to be measured, the respective scattered light being measured by the same radiation detector.

The two radiation detectors or, if just one radiation detector and two light sources are used, the two light sources may in each case be arranged at any angle to the optical axis, provided that the two radiation detectors or the two light sources are arranged on both sides of the optical axis. In order to simplify a correlation of the two different intensity profiles and the assignment thereof to the same particle, either the two radiation detectors or the two light sources should be spaced apart in the particle flight direction and arranged symmetrically with respect to the one light source (in the case of two radiation detectors) or with respect to the one radiation detector (in the case of two light sources).

Although computer-based evaluation is possible in principle also for a non-symmetrical arrangement, the relationships and thus the evaluation are simplified in the case of a symmetrical arrangement of the two radiation detectors or of the two light sources. Therefore, unless expressly indicated otherwise in what is stated below, the rest of the text proceeds from a symmetrical arrangement.

According to one advantageous embodiment of the concept of the invention, it is provided that either respectively a first and a second time-resolved intensity profile of light from the light source that is scattered at the particle is measured by two radiation detectors spaced apart in the particle flight direction and arranged on both sides of the light source, or that the particle is illuminated by two light sources spaced apart in the particle flight direction and arranged on both sides of the radiation detector and the time-resolved intensity profile measured by the radiation detector is broken down into a first intensity profile, caused by the first light source, and into a second intensity profile, caused by the second light source, that in each case two refraction peaks are determined from the first intensity profile and from the second intensity profile, that a first time difference between a first refraction peak of the first intensity profile and the first refraction peak of the second intensity profile and a second time difference between the second refraction peak of the first intensity profile and the second refraction peak of the second intensity profile are determined, that a characteristic variable β is determined as the ratio of the first time difference and the second time difference, and wherein a determination of size is carried out only for those particles for which the characteristic variable β corresponds to a predefinable value.

However, it is preferably provided that either the two radiation detectors are arranged symmetrically on both sides of the optical axis of the light source and respectively a first and a second time-resolved intensity profile of scattered light from the light source that is scattered at the particle is measured, or that the two light sources are arranged symmetrically on both sides of an optical axis of the radiation detector and the particle is illuminated by the two light sources arranged symmetrically and spaced apart in the particle flight direction.

By virtue of the arrangement of the measurement equipment, in particular the radiation detectors and the light sources, a temporal correlation of the respective intensity profiles can be carried out, so that the two intensity profiles which are assigned to the same particle can be clearly determined. The intensity of the refraction peak is usually much greater than the intensity of the reflection peak. Since the evaluation of the intensity profiles is limited to refraction peaks of two different intensity profiles of the same particle, greater intensity peaks can be evaluated and the necessary calculations can be carried out with considerably improved accuracy. The temporal spacing of the respective refraction peaks of two intensity profiles in this case depends, like the temporal spacing of refraction peaks and reflection peaks within one intensity profile, only on geometric preset values and on the particle size d, the particle speed v, the refractive index m and the scattering angle, which is identical on account of the symmetrical arrangement. The characteristic variable β, which describes the ratio of two such time differences, in contrast depends only on the refractive index m and the scattering angle θₛ and is therefore, like the characteristic variable γ, suitable for checking and selecting the measured values before carrying out a determination of the particle size using the measured values:

$$\frac{Δ {t}_{22}}{Δ {t}_{21}} = \frac{\frac{d / 2}{v} ( 2 sin ( {θ}_{i}^{p = 2.2} ( {θ}_{s} , m ) ) )}{\frac{d / 2}{v} ( 2 sin ( {θ}_{i}^{p = 2.1} ( {θ}_{s} , m ) ) )} = \frac{sin ( {θ}_{i}^{p = 2.2} ( {θ}_{s} , m ) )}{sin ( {θ}_{i}^{p = 2.1} ( {θ}_{s} , m ) )} := β ( {θ}_{s} , m )$$

In the same way as for the characteristic variable γ, it is advantageous that, for a known or predefined refractive index m, the scattering angle θₛ for subsequent measurements is predefined such that the characteristic variable β=Δt₂₂/Δt₁₁ is between 1.5 and 3.5, preferably more than 2.0 and particularly preferably more than 2.5. As a result, the spacing between the refraction peaks used for the evaluation is as large as possible, which is in turn advantageous for the temporal resolution of the signal.

For the case where the characteristic variable β=Δt₂₂/Δt₁₁ is measured with a non-symmetrical arrangement of the two radiation detectors (or of the two light sources), but rather the two radiation detectors (or the two light sources) have a different angle with respect to the optical axis and the intensity profiles are determined using different scattering angles θs⁽¹⁾ and θs⁽²⁾, the following relationships apply for the characteristic variable β(θs⁽¹⁾, θs⁽²⁾, m):

$$β ( {θ}_{s}^{( 1 )} , {θ}_{s}^{( 2 )} , m ) = \frac{Δ {t}_{22}}{Δ {t}_{11}} = \frac{\frac{d / 2}{v} [ sin ( {θ}_{i , ( 1 )}^{p = 2.2} ( {θ}_{s}^{( 1 )} , m ) ) + sin ( {θ}_{i , ( 2 )}^{p = 2.2} ( {θ}_{s}^{( 2 )} , m ) ) ]}{\frac{d / 2}{v} [ sin ( {θ}_{i , ( 1 )}^{p = 2.1} ( {θ}_{s}^{( 1 )} , m ) ) + sin ( {θ}_{i , ( 2 )}^{p = 2.1} ( {θ}_{s}^{( 2 )} , m ) ) ]} = \frac{sin ( {θ}_{i , ( 1 )}^{p = 2.2} ( {θ}_{s}^{( 1 )} , m ) ) + sin ( {θ}_{i , ( 2 )}^{p = 2.2} ( {θ}_{s}^{( 2 )} , m ) )}{sin ( {θ}_{i , ( 1 )}^{p = 2.1} ( {θ}_{s}^{( 1 )} , m ) ) + sin ( {θ}_{i , ( 2 )}^{p = 2.1} ( {θ}_{s}^{( 2 )} , m ) )}$$

The characteristic variable β can therefore also be determined for a non-symmetrical arrangement of the measurement components, or for scattering angles θs⁽¹⁾ and θs⁽²⁾ which differ from one another.

According to one particularly advantageous embodiment of the concept of the invention, it is provided that in addition the characteristic variable y is determined in each case for the first intensity profile and for the second intensity profile, and that, assuming that the characteristic variables γ are an identical match, the refractive index m for the particle in question is determined.

The refractive index m is obtained as a function of the scattering angle θₛ, which is now predefined identically again, and the geometrically predefined angles of incidence θᵢ^{p=21} and θᵢ^{p=22}, which in turn can be determined from the characteristic variables β and γ.

The relationships relevant for this can be illustrated by the formulae should below:

$$sin ( {θ}_{i}^{p = 21} ) = cos ( \frac{{θ}_{s}}{2} ) ( \frac{γ - 1}{β - γ} ) , \\ sin ( {θ}_{i}^{p = 22} ) = cos ( \frac{{θ}_{s}}{2} ) ( β \frac{γ - 1}{β - γ} )$$

$$and$$

$$m = \frac{sin ( {θ}_{i}^{p = 22} )}{sin ( \frac{π}{4} - \frac{{θ}_{s}}{4} + \frac{{θ}_{i}^{p = 22}}{2} )} = \frac{sin ( {θ}_{i}^{p = 21} )}{sin ( \frac{π}{4} - \frac{{θ}_{s}}{4} + \frac{{θ}_{i}^{p = 21}}{2} )}$$

In this way it is possible, by comparing a plurality of refraction peaks and a reflection peak within an individual intensity profile and by comparing a plurality of refraction peaks of two different intensity profiles of the scattered light from the same particle, to determine not only the size of said particle but also the refractive index m thereof and thus the nature thereof.

According to one advantageous embodiment of the concept of the invention, it is provided that a spatial intensity distribution of the light source along an optical axis is determined and is compared with a temporal intensity distribution of the reflection peak and/or of at least one refraction peak. As the light source, it is possible in principle to use any suitable light source, the light of which is scattered with sufficient intensity by the particle to be measured and the focused diameter of which is small enough in comparison to the particle size, so that a sufficient time difference exists between the individual reflection and refraction peaks for a predefined scattering angle θₛ. The temporal intensity distribution of any reflection or refraction peak corresponds here to the spatial intensity distribution of the light source that is scanned, as it were, by the particle flying past. An approximately Gaussian spatial intensity distribution of the light source leads to likewise Gaussian temporal intensity distributions of the reflection peak and of the refraction peaks.

In order to improve the reliability and validity of the particle size determinations carried out in each case, it is provided that a determination of size is carried out only for those particles for which the reflection peak and/or the two refraction peaks have a temporal intensity distribution that correlates with the spatial intensity distribution of the light source. A differing and non-correlating intensity distribution is a reliable indicator of the fact that the measured temporal intensity distribution cannot be assigned to an individual particle but rather has been caused by a superposition of the scatter components from a plurality of particles. It is also conceivable that the measured intensity distribution can be assigned to an individual particle but this particle does not have for example a spherical shape. In both cases, the validity of a particle size determined using these measured values would be extremely low. For this reason, no determination of the particle size is carried out for such non-correlated intensity distributions.

According to one particularly advantageous embodiment of the concept of the invention, it is provided that the speed of the particle is determined from a width of the temporal intensity distribution of the reflection peak and/or from a width of at least one refraction peak. Particularly for those intensity distributions for which the plausibility checks discussed above have been successfully carried out, the particle speed can be determined from a characteristic width of the temporal intensity distribution of a peak, provided that the correlating spatial beam width of the light source is known or can be determined beforehand by means of measurements. If the determination of the particle speed is carried out on a plurality of peaks or on the reflection peak and the two refraction peaks, the accuracy with which the particle speed is determined can be improved.

No additional measurement methods and no associated additional complexity in terms of apparatus is required in order to be able to determine both the particle speed and, knowing this, also the particle size. Since only the temporal intensity profile of the light from the light source that is scattered at the particle has to be measured in order to determine the particle size, the particle size can be determined in a quick, reliable and extremely cost-effective manner using the method described above.

The invention also relates to a device for determining the size and speed of a particle, comprising a light source, comprising a radiation detector for light from the light source that is scattered by the particle, and comprising an evaluation unit which can be connected to the radiation detector in a manner suitable for data transfer. According to the invention, it is provided that the light source emits non-coherent light. The light source may be for example a light-emitting diode (LED). The light source may also be formed from a plurality of LEDs which are arranged in a suitable manner. It is of course also possible to use for the measurement a light source which emits coherent light, although the use of coherent light is not necessary for carrying out the measurements.

In order to be able to carry out a quick and reliable determination of the particle size for a large number of particles which may possibly move in different directions, it is provided that the light source produces a light curtain.

### BRIEF DESCRIPTION OF THE DRAWINGS

Examples of embodiments will be discussed in more detail below and are shown in the drawing, in which:

FIG. 1 shows a schematic diagram of a particle illuminated by a light source and of the profiles of a few marked rays occurring for a predefined scattering angle θₛ,

FIG. 2 shows a schematic relationship between the spatial intensity distribution of a light ray from the light source that is incident on the particle and a temporal intensity distribution, correlating therewith, of the measured scattered light,

FIG. 3 shows a schematically depicted temporal intensity profile of the light scattered by the particle at the scattering angle θₛ,

FIG. 4 shows a schematic diagram of different values of the characteristic variable y as a function of different materials or refractive indices m of the particle,

FIG. 5 shows a schematic diagram of a device for determining the size of a particle according to the method described above,

FIG. 6 shows a schematic diagram of a measurement device according to FIG. 5, wherein two radiation detectors are arranged symmetrically on both sides of a light source,

FIG. 7 shows a schematic diagram of the temporal intensity profiles of the scattered light from a particle, measured by the two radiation detectors,

FIG. 8 shows a schematic diagram, comparable to FIG. 4, of different values of the characteristic variable β as a function of different materials or refractive indices m of the particles, wherein a symmetrical arrangement of the two radiation detectors is shown, and

FIG. 9 shows a diagram of an evaluation of determined refractive indices m for particles of different materials based on the measured intensity profiles.

### DESCRIPTION OF VARIOUS AND PREFERRED EMBODIMENTS

FIG. 1 schematically shows the marked rays relevant for the method according to the invention for determining the particle size, in a scattering process at a scattering angle θₛ. From a light source (not shown in FIG. 1), a light ray 1 having a schematically indicated spatial intensity distribution is incident on a particle 2 which moves through the light ray 1 in a manner crossing the light ray. The light ray 1 is reflected from outside at the interface 3 between the particle 2 and the surrounding medium and is scattered by birefringence and internal reflection. FIG. 1 shows various marked rays which can be detected at a predefined scattering angle θₛ.

A reflection ray 4 is reflected at the interface 3. A first refraction ray 5 and a second refraction ray 6 are refracted into the particle 2, reflected from inside at the interface 3 and refracted again upon leaving the particle 2. In addition to the reflection ray 4 and the two refraction rays 5 and 6, surface rays 7 and 8 which are incident tangentially along the interface 3 are guided along a circumferential line around the interface 3 of the particle 2 and can likewise be detected at the predefined scattering angle θₛ.

The respective angle of incidence θᵢ of the marked rays, which produce corresponding intensity peaks in a time-resolved intensity profile, correlates with the point of impact on the interface 3 of the particle 2. For an assumed ideal spherical shape of the particle 2, the angles of incidence θᵢ can be determined as a function of the scattering angle θₛ used for the measurement and the refractive index m of the particle 2 with the aid of geometric considerations, or in practice with the aid of ray tracing programs or optics simulation programs.

Due to the different paths and propagation times, which given a predefined scattering angle θs can be determined beforehand both for the reflection ray 4 and for the refraction rays 5 and 6 as well as for the surface rays 7 and 8, the individual rays produce temporally spaced-apart peaks which can be detected by a detector (not shown). Since the time difference between individual peaks depends inter alia on the particle size, the particle size can be determined from a time-resolved intensity profile that has been detected by the detector.

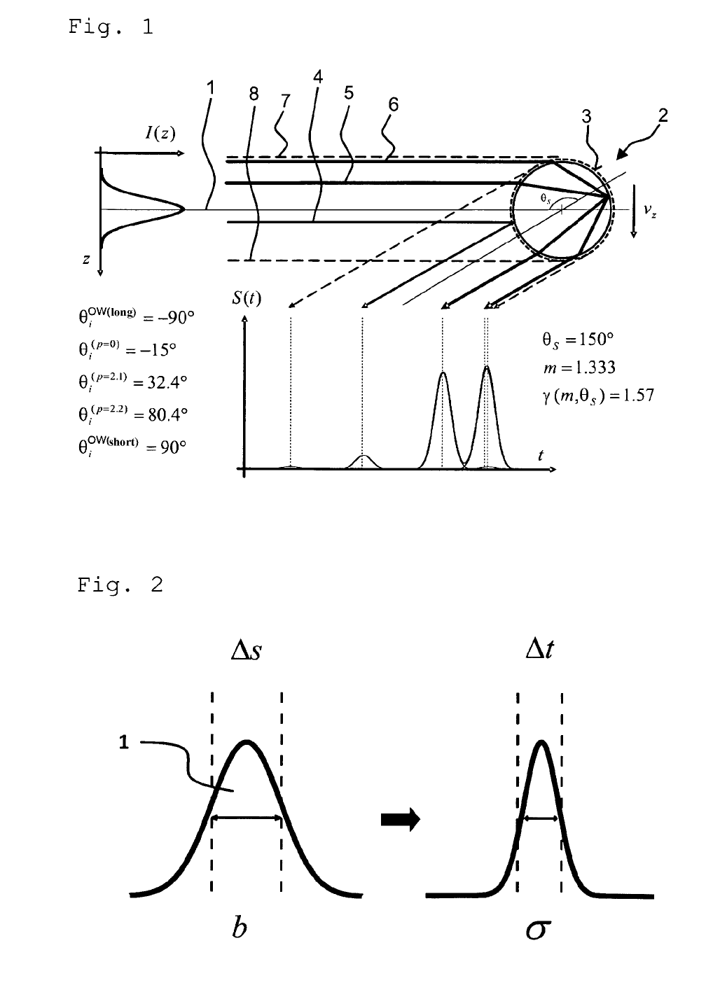

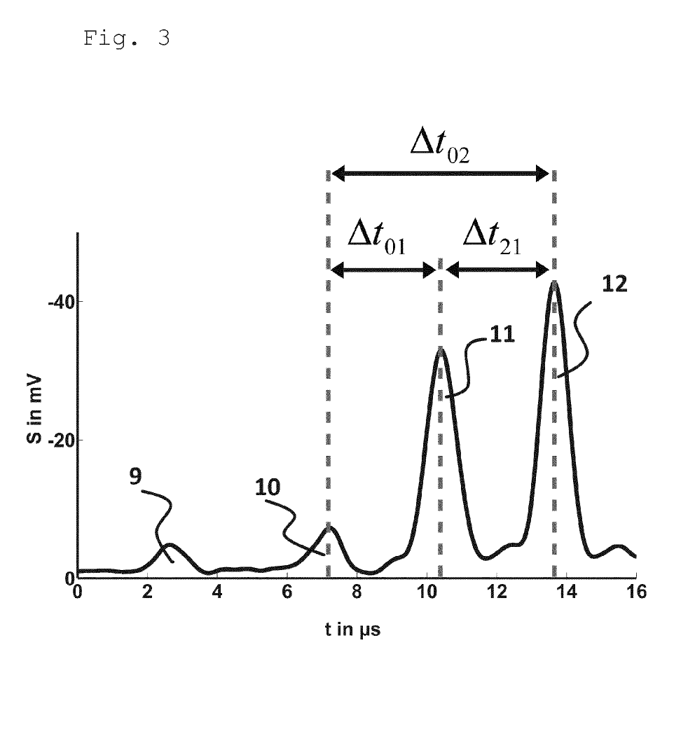

FIG. 2 shows, only schematically, the relationship between a spatial intensity distribution of the incident light ray 1 and the temporal intensity profile of the scattered light detected at the scattering angle θₛ. A substantially Gaussian intensity distribution of the incident light ray 1 leads to a likewise approximately Gaussian temporal profile of the measured intensity of the scattered light. Such an intensity peak can be measured for all the marked rays described above.

As a result of the particle 2 crossing the light ray 1, the light ray 1 that is incident on the particle 2 is imaged in the detector, which can be described by a mathematical transformation. The width b of the spatial intensity distribution of the incident light ray 1 corresponds here to the width a of the time-resolved peak of the scattered light. The particle speed v is obtained from the quotient of the spatial width b and the time difference corresponding to the width σ:

v=b/σ.

The width b and the width a can be determined for example via a half-width determination of the respective peaks. The spatial intensity distribution of the incident light ray 1 should therefore be determined as precisely as possible beforehand.

FIG. 3 schematically shows a time-resolved intensity profile of the scattered light at the particle 2, measured at the scattering angle θₛ. Here, in a manner representative of the intensity, the electrical measurement signal S produced by a detector is plotted in mV over time t in μs. The intensity profile exhibits clearly separate and distinguishable peaks 9, 10, 11 and 12, which can be assigned to the individual rays 4, 5, 6, 7 and 8. A surface peak 9 is produced by surface rays 8 and is of no further relevance for the determination of particle size. The intensity of a second surface peak, which is produced by the surface rays 7, is too low and is not shown in the intensity profile. Spaced apart temporally therefrom, it is possible to identify a reflection peak 10, a first refraction peak 11 and a second refraction peak 12. The time differences Δt₀₁ and Δt₀₂ can be determined as the difference of the respective maxima of the reflection peak 10 and of the two refraction peaks 11, 12. In the schematically shown intensity profile, the first refraction peak 11 corresponds to a second-order scattered light ray having a first mode, while the second refraction peak 12 corresponds to a second-order scattered light ray having a second mode.

The time differences Δt₀₁ and Δt₀₂ are in each case dependent on the size d of the particle 2. In contrast, a characteristic variable γ, which is determined as a quotient from the two time differences Δt₀₁ and Δt₀₂ according to the following relationship

$$\frac{Δ {t}_{02}}{Δ {t}_{01}} = \frac{\frac{d / 2}{v} ( cos ( \frac{{θ}_{s}}{2} ) + sin ( {θ}_{i}^{p = 2.2} ( {θ}_{s} , m ) ) )}{\frac{d / 2}{v} ( cos ( \frac{{θ}_{s}}{2} ) + sin ( {θ}_{i}^{p = 2.1} ( {θ}_{s} , m ) ) )} = \frac{( cos ( \frac{{θ}_{s}}{2} ) + sin ( {θ}_{i}^{p = 2.2} ( {θ}_{s} , m ) ) )}{( cos ( \frac{{θ}_{s}}{2} ) + sin ( {θ}_{i}^{p = 2.1} ( {θ}_{s} , m ) ) )} := γ ( {θ}_{s} , m ) ,$$

is independent of the particle size d and depends only on the scattering angle θₛ and a relative refractive index m. The scattering angle θₛ can be predefined by the equipment set-up of the measurement apparatus and/or by the arrangement and orientation of a detector relative to the light source. The relative refractive index m can likewise be determined beforehand for known particles 2 in a known medium. The two angles of incidence θᵢ^{p=2.2} and θᵢ^{p=2.1} are geometric variables which, assuming an ideal spherical shape of the particle, depend only on the scattering angle es and the relative refractive index m. The characteristic variable γ can thus likewise be determined beforehand and a value or a value range can be predefined to which the characteristic variable γ determined from the measured intensity distribution must correspond in order for the intensity distribution in question to be taken into account and used for determining a particle size.

If a considerably differing characteristic variable y is obtained from the measured intensity distribution, then this often has to be attributed to the fact that the individual peaks 10, 11 and 12 cannot be assigned to a single particle 2, but rather result for example from a superposition of a plurality of scattering effects at different particles, or else the particle in question does not have an approximately spherical shape and therefore the geometric boundary conditions assumed for the paths and propagation times of the marked rays 4, 5 and 6 are incorrect.

Instead of the ratio of the time differences Δt₀₁ and Δt₀₂ or in addition thereto, it is also possible to determine in a measured intensity distribution the time difference Δt₁₂ of the two refraction peaks 11 and 12 relative to one another and to use this in the respective ratio to the time differences Δt₀₁ and Δt₀₂ to calculate the characteristic variable γ, wherein the following relationships apply:

$$\frac{Δ {t}_{21}}{Δ {t}_{01}} = \frac{\frac{d / 2}{v} ( sin ( {θ}_{i}^{p = 2.2} ( {θ}_{s} , m ) ) - sin ( {θ}_{i}^{p = 2.1} ( {θ}_{s} , m ) ) )}{\frac{d / 2}{v} ( cos ( \frac{{θ}_{s}}{2} ) + sin ( {θ}_{i}^{p = 2.1} ( {θ}_{s} , m ) ) )} = \frac{( cos ( \frac{{θ}_{s}}{2} ) + sin ( {θ}_{i}^{p = 2.2} ( {θ}_{s} , m ) ) )}{( cos ( \frac{{θ}_{s}}{2} ) + sin ( {θ}_{i}^{p = 2.1} ( {θ}_{s} , m ) ) )} - 1 := γ ( {θ}_{s} , m ) - 1$$

$$and$$

$$\frac{Δ {t}_{21}}{Δ {t}_{02}} = \frac{\frac{d / 2}{v} ( sin ( {θ}_{i}^{p = 2.2} ( {θ}_{s} , m ) ) - sin ( {θ}_{i}^{p = 2.1} ( {θ}_{s} , m ) ) )}{\frac{d / 2}{v} ( cos ( \frac{{θ}_{s}}{2} ) + sin ( {θ}_{i}^{p = 2.2} ( {θ}_{s} , m ) ) )} = 1 - \frac{( cos ( \frac{{θ}_{s}}{2} ) + sin ( {θ}_{i}^{p = 2.1} ( {θ}_{s} , m ) ) )}{( cos ( \frac{{θ}_{s}}{2} ) + sin ( {θ}_{i}^{p = 2.2} ( {θ}_{s} , m ) ) )} := 1 \frac{1}{γ ( {θ}_{s} , m )}$$

With each of these formulae, the value of the characteristic variable y can be determined independently of the respective other relationships.

In addition, it is possible to carry out two or three different calculations for the characteristic variable γ and to compare the values obtained in each case. If the values determined in each case for the characteristic variable γ do not match, the intensity distributions in question should not be used for an evaluation since differences in the characteristic variable γ also indicate that the individual peaks 10, 11 and 12 cannot be assigned to a single particle 2.

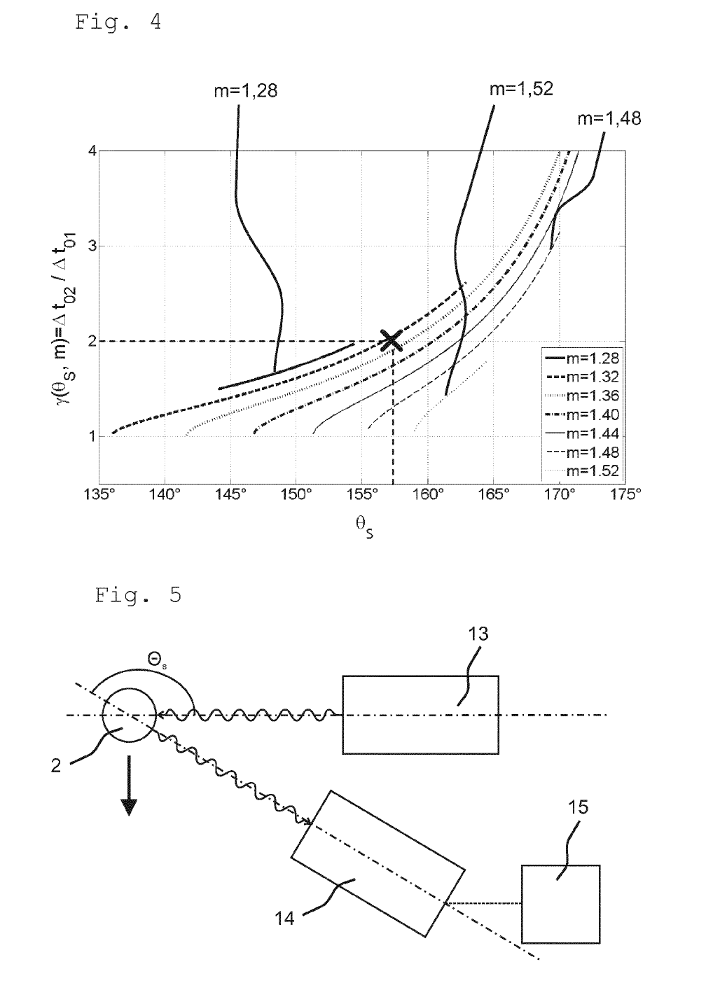

In FIG. 4, the theoretically determined values for the characteristic variable γ are shown over the scattering angle θₛ in degrees for different refractive indices between m=1.28 and m=1.52 in steps of in each case 0.04. For evaluating the measurement results, a value of 2 for the characteristic variable γ is advantageous. This leads to the situation whereby for example for measuring the size of water droplets in air having a refractive index m=1.33, a scattering angle es of approximately 157° is particularly advantageous and should be taken into account and optionally preset for the design set-up of a measurement apparatus.

A device for carrying out the method described above requires only a few inexpensive components. A light source 13 and a photodetector 14 must be arranged and oriented relative to one another such that the light scattered by a particle 2 flying past can be detected at the scattering angle θₛ. Since no interference properties have to be used for determining the particle size d, the light source 13 can be any light source of suitable brightness which can be focused in a suitable manner. The light source 13 need not emit coherent light, so that it is also possible to use LEDs for example. If the sizes d of particles 2 having different trajectories are to be determined, the light source 13 can also be configured as a light curtain or the like. Connected to the photo detector 14 in a manner suitable for data transfer is an evaluation unit 15 which is suitable for evaluating, in the manner described above, a time-resolved intensity distribution measured by the photodetector 14. The evaluation unit 15 optionally has a suitable memory device for the measured values.

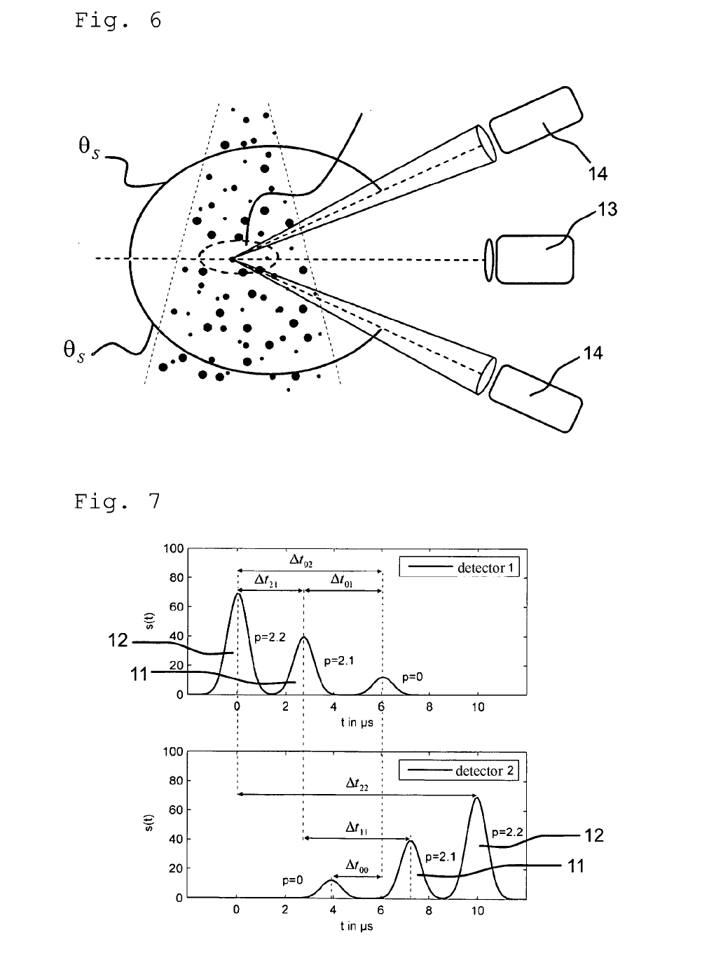

Described in FIG. 6 is a measuring device of different configuration, in which two photodetectors 14 can be used simultaneously to measure two different time-resolved intensity distributions. One photodetector 14 is arranged on each side of the light source 13. The orientation of the two photodetectors 14 relative to the light source corresponds to the anticipated flight direction of the particles 2 flying past. The two photodetectors 14 are oriented symmetrically with respect to the light source 13 and relative to one another such that both photodetectors 14 detect the scattered light coming from an identical measurement volume 16 in the particle stream. The intensity profiles measured by the two photodetectors 14 therefore correspond under otherwise ideal conditions of the scattered light intensity profile of the same particle measured at the same scattering angle θₛ. It is of course also possible to orient the two photodetectors 14 at a different angle to the optical axis defined by the light source, so that time-resolved intensity profiles can be measured at two different scattering angles θs⁽¹⁾ and θs⁽²⁾ and the characteristic variable β(θs⁽¹⁾, θs⁽²), m) then depends on the two scattering angles.

FIG. 7 schematically shows the temporal intensity profiles measured by the two photodetectors 14 for the scattered light that has been produced by the light source 13 at a particle 2 flying through the measurement volume 16.

The temporal intensity profiles appear to be mirror images, due to the arrangement of the two photodetectors 14 relative to the light source 13 before and after the light source in the flight direction.

The first time difference Δt₁₁ between the respective second-order refraction peaks 11 having the 1st mode and the second time difference Δt₂₂ between the respective second-order refraction peaks 12 having the 2nd mode depend on the properties of the particle 2, according to the following formulae:

$$Δ {t}_{11} ( d , v , {θ}_{s} , m ) = \frac{d}{v} ( sin ( {θ}_{i}^{( p = 2.1 )} ( {θ}_{s} , m ) ) )$$

$$Δ {t}_{22} ( d , v , {θ}_{s} , m ) = \frac{d}{v} ( sin ( {θ}_{i}^{( p = 2.2 )} ( {θ}_{s} , m ) ) )$$

However, the ratio of these two time differences Δt₂₂/Δt₁₁ depends only on the scattering angle θₛ predefined by the measuring device (said scattering angle being identical for the two photodetectors 14) and on the refractive index m and serves as the characteristic variable β:

$$\frac{Δ {t}_{22}}{Δ {t}_{11}} = \frac{\frac{d / 2}{v} ( 2 sin ( {θ}_{i}^{p = 2.2} ( {θ}_{s} , m ) ) )}{\frac{d / 2}{v} ( 2 sin ( {θ}_{i}^{p = 2.1} ( {θ}_{s} , m ) ) )} = \frac{sin ( {θ}_{i}^{p = 2.2} ( {θ}_{s} , m ) )}{sin ( {θ}_{i}^{p = 2.1} ( {θ}_{s} , m ) )} := β ( {θ}_{s} , m )$$

Since only second-order refraction peaks of strong intensity are used to determine the characteristic variable β, this characteristic variable β can be determined very precisely.

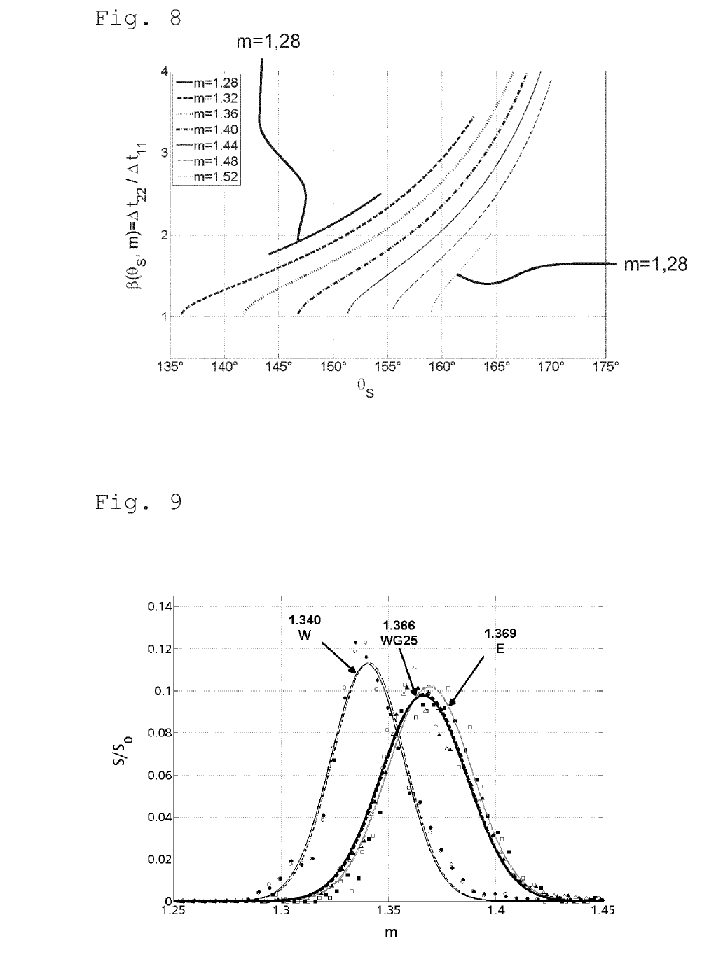

The experimentally confirmed dependence of the characteristic variable β on the scattering angle θₛ is shown schematically in FIG. 8 for different materials and refractive indices m of particles 2.

For an evaluation and for determining the size of the particle 2, use is made only of those measured values or measured time-resolved intensity profiles for which the characteristic variable β as a function of the predefined scattering angle θₛ lies in a predefinable value range such as for example 1.95<β<2.05, or for which the characteristic variable β has a predefined value such as for example 2.0. All the other measured values are discarded. For the remaining measured values, very precise and meaningful results are obtained.

For the same particle 2, for which the characteristic variable β satisfies the predefined criterion, the characteristic variables γ which can be determined in each case from the individual intensity profiles should also satisfy the corresponding criterion. Moreover, the two characteristic variables γ should be an identical match, since the two intensity profiles correspond to the scattered light from the same particle 2 produced by the same light source 13.

The angles of incidence θᵢ of the respectively refracted or reflected second-order rays are—as discussed above—dependent on the scattering angle θₛ and the refractive index m. Via the determined characteristic variables β and γ, which in turn depend on the angles of incidence θᵢ of the refracted or reflected rays in question, these angles of incidence θᵢ can be determined without knowing the refractive index m, according to the following formulae:

$$sin ( {θ}_{i}^{p = 21} ) = cos ( \frac{{θ}_{s}}{2} ) ( \frac{γ - 1}{β - γ} )$$

$$and$$

$$sin ( {θ}_{i}^{p = 22} ) = cos ( \frac{{θ}_{s}}{2} ) ( β \frac{γ - 1}{β - γ} ) .$$

From the known dependence of these angles of incidence θᵢ on the refractive index m, the refractive index m can be calculated as follows:

$$m = \frac{sin ( {θ}_{i}^{p = 22} )}{sin ( \frac{π}{4} - \frac{{θ}_{s}}{4} + \frac{{θ}_{i}^{p = 22}}{2} )} = \frac{sin ( {θ}_{i}^{p = 21} )}{sin ( \frac{π}{4} - \frac{{θ}_{s}}{4} + \frac{{θ}_{i}^{p = 21}}{2} )} .$$

In this way, based on the measured intensity profiles, it is possible to determine not only the size but also the refractive index m of the particle 2 detected by the measurement.

FIG. 9 shows the experimentally determined measurement results for the refractive index m of particles 2 of different materials. With the measuring device used, it is possible for example to distinguish readily between water droplets “W” (m=1.340) and ethanol droplets “E” (m=1.369). The measurement results for a refractive index m=1.362 of a mixture “WG25” consisting of 1 part by weight glycerol and 4 parts by weight water are also shown. Such a mixture having a slightly different relative refractive index m can be clearly distinguished from water or ethanol.

1. A method for determining characteristic properties of a transparent particle, wherein the particle is illuminated with light from a light source, wherein a time-resolved intensity profile of light from the light source that is scattered at the particle is measured by a radiation detector at a predefinable scattering angle θₛ, wherein characteristic scattered light peaks are determined in the intensity profile, and wherein a size of the particle is determined based on a time difference between two scattered light peaks,
wherein a first time difference is determined between a first pair of scattered light peaks and a second time difference is determined between a second pair of scattered light peaks, a characteristic variable is determined from the ratio of the first time difference and the second time difference, and a determination of size is carried out only for those particles for which the characteristic variable lies within a predefinable value range.

2. The method according to claim 1, wherein the scattering angle θₛ is greater than 135°.

3. The method according to claim 2, wherein a first refraction peak and a second refraction peak are determined, wherein a characteristic variable γ is determined as the ratio of a first time difference Δt₀₁ between the reflection peak and the first refraction peak and a second time difference Δt₀₂ between the reflection peak and the second refraction peak, and wherein a determination of size is carried out only for those particles for which the characteristic variable γ corresponds to a predefinable value.

4. The method according to claim 3, wherein the first refraction peak is a second-order refraction peak having a first mode and the second refraction peak is a second-order refraction peak having a second mode.

5. The method according to claim 2, wherein the scattering angle θₛ is predefined such that the characteristic variable γ=Δt₀₂/Δt₀₁ is between 1.5 and 2.5.

6. The method according to claim 1, wherein one of several predefined refractive indices m is assigned to the particle based on the characteristic variable γ.

7. The method according to claim 1, wherein either:
respectively a first and a second time-resolved intensity profile of light from the light source that is scattered at the particle is measured by two radiation detectors spaced apart in the particle flight direction and arranged on both sides of the light source, or the particle is illuminated by two light sources spaced apart in the particle flight direction and arranged on both sides of the radiation detector and the time-resolved intensity profile measured by the radiation detector is broken down
into a first intensity profile, caused by the first light source, and
into a second intensity profile, caused by the second light source, wherein in each case two refraction peaks are determined from the first intensity profile and from the second intensity profile, in that a first time difference between a first refraction peak of the first intensity profile and the first refraction peak of the second intensity profile and a second time difference between the second refraction peak of the first intensity profile and the second refraction peak of the second intensity profile are determined, wherein a characteristic variable β is determined as the ratio of the first time difference and the second time difference, and wherein a determination of size is carried out only for those particles for which the characteristic variable β corresponds to a predefinable value.

8. The method according to claim 7, wherein either the radiation detectors arranged on both sides of the light source are spaced apart in the particle flight direction and are arranged symmetrically on both sides of the light source, or in that, if a single radiation detector and two light sources are used, the light sources are spaced apart in the particle flight direction and are arranged symmetrically on both sides of the radiation detector.

9. The method according to claim 7, wherein, for a known or predefined refractive index m, the scattering angle θₛ or the two θs⁽¹) and θs⁽²⁾ for subsequent measurements are predefined such that the characteristic variable β=Δt₂₂/Δ₁₁ is between 1.5 and 3.5.

10. The method according to claim 7, wherein in addition the characteristic variable γ is determined for the first intensity profile and for the second intensity profile, and wherein, assuming that the characteristic variables γ are an identical match, the refractive index m for the particle in question is determined.

11. The method according to claim 1, wherein a spatial intensity distribution of the light source along an optical axis is determined and is compared with a temporal intensity distribution of the reflection peak and/or of at least one refraction peak.

12. The method according to claim 11, wherein a determination of size is carried out only for those particles for which the reflection peak and/or the two refraction peaks have a temporal intensity distribution that correlates with the spatial intensity distribution of the light source.

13. The method according to claim 11, wherein the speed v of the particle is determined from a width σ of the temporal intensity distribution of the reflection peak and/or from a width σ of at least one refraction peak.

14. A device for determining the size of a particle, comprising a light source, comprising a radiation detector for light from the light source that is scattered by the particle, and comprising an evaluation unit which can be connected to the radiation detector in a manner suitable for data transfer, wherein the light source is adapted to emit coherent or non-coherent light.

15. The device according to claim 14, wherein the light source comprises an LED.

16. The device according to claim 14, wherein the light source is adapted to produce a light curtain.

17. The device according to claim 14, wherein two radiation detectors are spaced apart in the particle flight direction and are arranged on both sides of the light source, symmetrically with respect thereto, in order to detect back-scattered light.

18. The method according to claim 5, wherein the scattering angle θₛ is predefined such that the characteristic variable γ=Δt₀₂/Δt₀₁ is around 2.0.

19. The method according to claim 9, wherein, for a known or predefined refractive index m, the scattering angle θₛ or the two θs⁽¹⁾ and θs⁽²⁾ for subsequent measurements are predefined such that the characteristic variable β=Δt₂₂/Δt₁₁ is more than 2.0.

20. The method according to claim 9, wherein, for a known or predefined refractive index m, the scattering angle θₛ or the two θs⁽¹⁾ and θs⁽²⁾ for subsequent measurements are predefined such that the characteristic variable β=Δt₂₂/Δt₁₁ is more than 2.5.
